(19) United States
(12) Patent Application Publication
(10) Pub. No.: US 2007/0002784 A1
(43) Pub. Date: Jan. 4, 2007

(54) Systems, methods, and media for notifying users of events on a remote control device

(76) Inventor: David A. Edwards, Phoenix, AZ (US)

Correspondence Address: SCHUBERT, OSTERRIEDER & NICKELSON, PLLC;c/o PORTFOLIOIP, P.O. BOX 52050, MINNEAPOLIS, MN, 55402, US

(21) Appl. No.: 11/170,971

(22) Filed: Jun. 30, 2005

(51) Int. Cl. H04J 3/08; H04B 7/14

(52) U.S. Cl. 370/315

(57) ABSTRACT

Systems, methods, and media for notifying users of personal computer system events on a remote control device are disclosed. Some embodiments may comprise a remote control device associated with an electronic device having a computer system communications module to receive an indication of an occurrence of an event from a personal computer system and a processor to process the received indication of the event occurrence. Embodiments may further include a user interface having a user output device such as a display to notify a user of the event occurrence and a user input device to receive commands from a user for the electronic device. Further embodiments may also include a remote transmitter to transmit commands from the remote control device to the electronic device. Other embodiments may include a user input device to receive a response to the event occurrence from the user. Other embodiments are disclosed and claimed.

### FIELD

The present invention is in the field of computer systems. More particularly, the present invention relates to systems, methods, and media to notify a user of a remote control device of the occurrence of an event at a personal computer system.

### BACKGROUND

Networking between computer systems has become an integral part of computing technology. Computer systems are connected to each other through a network such as a local area network (LAN) to enable communication and sharing of information between users of the different computer systems. An Internet connection often further complements the network, providing access to vast amounts of data. As networking technology becomes more inexpensive and less difficult to manage, home networks connecting multiple personal computers (PCs) are increasing in popularity. Multiple users of a home network use the network to, say, play video games against each other or to share a printer or Internet connection over the home network. Similarly, home users are also taking advantage of improvements in wireless networking technology to implement wireless home networks that interconnect PCs as well mobile devices (such as wireless phones or personal digital assistants (PDAs)) or consumer electronic (CE) devices (such as televisions (TVs), stereos, or DVD players) to a home network and to each other. Many wireless networking or communication technologies are available for home users, such as Bluetooth® wireless technology or Wireless Universal Serial Bus (WUSB).

Advancements in computer technology (both in hardware and software) allow a PC in a home network to have numerous multimedia capabilities, such as playing music or displaying video. A user typically sits in front of their PC and interacts using a keyboard and mouse and receives information from the PC from its display and speakers. With an Internet connection, the PC has the capability to bring additional multimedia information to a user. While PCs have significantly increased capability to deliver multimedia entertainment, large CE devices such as TVs, stereos, or DVD players still, however, often remain the center of the entertainment experience in most households. PCs can stream content to these CE devices but such capability still has some problems. A user watching a movie streamed from the PC to a CE device located in another room, for example, often cannot see the PC display or hear its audio while watching the content, potentially hampering the user experience.

Manufacturers and software vendors have begun to address the integration of home networks, multimedia PCs, and CE devices. These manufacturers and vendors have developed protocols and standards that allow for interoperability between PCs and CE devices so that, for example, PCs may manage or distribute multimedia content between multiple CE devices using the home network. Increased usage of home networks for multimedia entertainment, however, will require continued improvement of the integration between the different systems as well as improvement of the overall user experience (including both desirability of features and ease of use).

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an embodiment of a system having a personal computer system, a digital media adapter, an electronic device, and a remote control device;

FIG. 2 depicts the remote control device of FIG. 1 according to one embodiment;

FIG. 3 depicts an embodiment of the system of FIG. 1 implemented in a home network environment; and

FIG. 4 depicts a flowchart of an embodiment to notify a user of a remote control system of the occurrence of an event; and

FIG. 5 depicts a flowchart of an embodiment to detect the occurrence of an event and to transmit an indication of the event occurrence to a remote control device.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for notifying users of personal computer system events on a remote control device are disclosed. Some embodiments may comprise a remote control device associated with an electronic device having a computer system communications module to receive an indication of an occurrence of an event from a personal computer system and a processor to process the received indication of the event occurrence. Embodiments may further include a user interface having a user output device such as a display to notify a user of the event occurrence and a user input device to receive commands from a user for the electronic device. Further embodiments may also include a remote transmitter to transmit commands from the remote control device to the electronic device. Other embodiments may include a user input device to receive a response to the event occurrence from the user.

Another embodiment comprises a method for notifying a user of an event occurrence. The method may generally include receiving from a personal computer system, at a remote control device associated with an electronic device, an indication of an event occurrence at the personal computer system and processing the indication of the event occurrence to generate a notification of the event occurrence. The method may also generally include notifying by a user output device of the remote control device a user of the event occurrence.

The disclosed system and methodology may advantageously provide for notifying users utilizing a remote control device of an electronic device of the occurrence of an event at a personal computer system. When an event occurs, the personal computer system may transmit an indication of the event to the remote control device using, for example, a home wireless network or point-to-point communication protocol. A user may thus receive communications from (and may also transmit responses to) a personal computer system even though they cannot see its display or access its keyboard, such as when the user is in a different room from the personal computer system or the display of the personal computer system is unavailable. This may allow a user to interact with the personal computer system without intruding on their use of a television, stereo or other electronic device and without interrupting the playback of digital content. The user may also respond to the notification from anywhere within the home network, providing additional flexibility and ease of use. In another example, a user may be using the personal computer system with its display in full screen mode may advantageously interact with the personal computer system using the remote control device so that their full screen viewing is not interrupted or disturbed by pauses, pop-up windows, or the like initiated by the personal computer system.

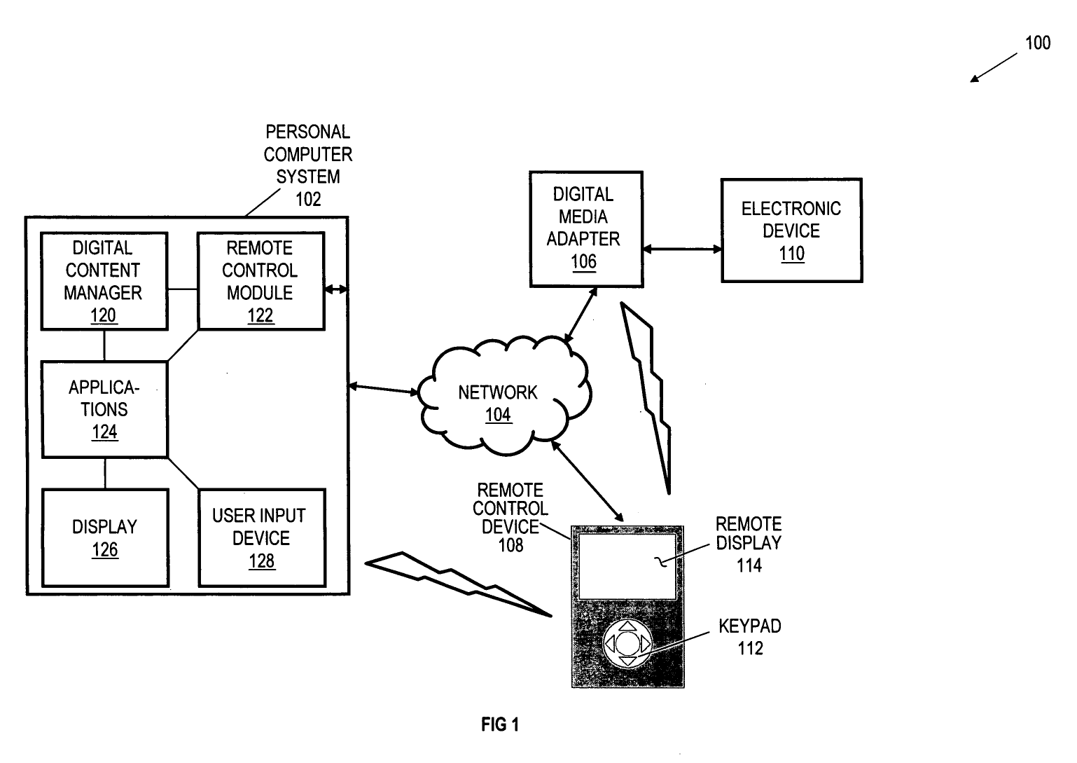

Turning now to the drawings, FIG. 1 depicts an embodiment of a system having a personal computer system, a digital media adapter, an electronic device, and a remote control device. In user notification system 100, the personal computer system 102 may be coupled with a digital media adapter (DMA) 106 via a network 104. An electronic device 110 may be coupled with the DMA 106, while the remote control device 108 may be in communication with the DMA 106 so that a user of the remote control device 108 may control the electronic device 110. The remote control device 108 may also be in communication with the personal computer system 102, such as via the network 104, point-to-point connection, or through the DMA 106. As will be described in more detail subsequently, a user of the remote control device 108 may receive notifications of the occurrence of different events originating from the personal computer system 102. By receiving such notifications at a remote control device 108 and not having to rely on a display of the personal computer system 102 to receive notifications, a user may thus receive useful information or notifications from a wide variety of locations (e.g., throughout the house) and in a variety of different situations (e.g., when the personal computer system 102 display is unavailable because it is occupied with a full screen view). The user of the remote control device 108 may, in one embodiment, also advantageously interact with the personal computer system 102 using the remote control device 108 without having to access the keyboard, mouse or other input device of the personal computer system 102, providing additional flexibility in the user experience.

Personal computer system 102 may be a general or special purpose computer system such as one or more of a PC, workstation, server, mainframe computer, notebook or laptop computer, tablet PC, desktop computer, portable computer system, or the like. The computer system may, in one embodiment, include a central processing unit (CPU) and associated volatile and non-volatile memory, including random access memory (RAM) and basic input/output system read only memory (BIOS ROM), a system monitor, a keyboard, one or more flexible diskette drives, a CD-ROM drive, a fixed disk storage drive (also known as a “hard drive” or “hard disk drive”), a pointing device such as a mouse, and an optional network interface adapter, all electrically connected using a motherboard or system planar. In one embodiment, personal computer system 102 may serve as a part of a digital home entertainment system and may facilitate delivery of multimedia content to other components of the user notification system 100, such as the DMA 106 or electronic device 110.

The personal computer system 102 of the depicted embodiment includes a digital content manager 120, a remote control module 122, one or more applications 124, a display 126, and one or more user input devices 128. The digital content manager 120 may facilitate sharing or distribution of digital content amongst the components of the user notification system 100. Any of the components of the user notification system 100 may store digital content for distribution to other components, and components may also access digital content from sources outside the user notification system 100, such as from the Internet or over a cable line or satellite link. Digital content may include any type of multimedia content, such as audio (e.g., music), video (e.g., programs, movies, etc.), images (e.g., photographs, charts, etc.), or the like. Digital content may include both content protected by Digital Rights Management (DRM) or other copyright protection methodologies as well as unrestricted content. The digital content manager 120 may include software such as Microsoft Corporation's Media Center Edition to manage multimedia digital content. Alternatively, personal computer system 102 may be a different type of digital content source device such as an advanced digital set-top box (STB), access platform (i.e., residential gateway), or the like.

The personal computer system 102 may use the remote control module 122 to send and receive communications to and from the remote control device 108 and to manage the remote control device 108. The remote control module 122 may communicate with the remote control device 108 via network 104, through the DMA 106 or electronic device 110, or via point-to point communication techniques such as Bluetooth® wireless technology (Bluetooth Specification v1.3, Bluetooth Special Interest Group, 2003), Wireless Universal Serial Bus (WUSB) (Wireless USB Promoters Group, 2004) or other technology. Personal computer system 102 may include one or more applications 124 for managing digital content, where managing digital content may include playing, downloading, storing, creating, distributing, hosting, accessing, or otherwise handling digital content. Example applications 124 may include a digital tuner, Microsoft Windows Media Player and Media Center Edition, Dell Computer Corporation's Dell Media Experience, Apple Computer Inc.'s iTunes and Quicktime, or other digital content applications. Personal computer system 102 may also include a display 126 for displaying digital content or information to a user such as a computer monitor. User input device 128 may include any device suitable for inputting information or commands to personal computer system 102, such as a keyboard, keypad, mouse, audio input device, or the like.

Network 104 may be any type or combination of data communications channels, such as LAN or wide area network (WAN), to couple components of the user notification system 100. Network 104 may include any combination of wired or wireless networks. In some embodiments, network 104 may include a network in a home coupled via Ethernet, optical media, a wireless network, or the like. In several embodiments, network 104 also couples with the Internet via a cable modem, a digital subscriber line (DSL), a T1 line, a T3 line, satellite link or the like. In further embodiments, network 104 may include a network of temporary connections such as connections via a telephone system. Components of the user notification system 100 may utilize a wide variety of wired or wireless schemes including Ethernet (Institute of Electrical and Electronic Engineers (IEEE) Standard 802.3-2002, Carrier Sense Multiple Access with Collision Detection (CSMA/CD) Access Method and Physical Layer Specifications, 2002), Home Phoneline Networking Alliance (HomePNA) (HomePNA Specification 3.0, 2002), Home Radio Frequency (HomeRF) (HomeRF 2.0 Specification, 2002, from the Home Radio Frequency Working Group, Inc.), IEEE Standard 802.11b (Higher-Speed Physical Layer Extension in the 2.4 GHz Band, 1999), IEEE Standard 802.11a (A Very-High-Speed, Highly Scalable Wireless LAN Standard, 1997), IEEE Standard 802.11g (2003), IEEE 1394 (IEEE Standard for a High Performance Serial Bus—Firewire, 1995), and Digital Living Network Alliance (DLNA) (DLNA Home Networked Device Interoperability Guidelines v1.0, 2004). Those skilled in the art will recognize, however, that the invention described herein may be implemented utilizing any type of data communications channel.

A DMA 106 may be coupled to the personal computer system 102 and to one or more electronic devices 110 according to one embodiment. The DMA 106 may allow for transmission and receipt of digital content between a personal computer system 102 and any electronic devices 110. In one embodiment, the DMA 106 utilizes the Intel® Networked Media Product Requirements (NMPR) guidelines (promulgated by Intel Corporation) for interoperability with the personal computer system 102. Satisfying NMRP may require a device such as a DMA to conform to standards and protocols such as the IEEE 802.11 standards for wireless networking and the Universal Plug and Play (UPnP) and UPnP Audio Visual (AV) standards for installation and connectivity of media devices. The DMA 106 may be coupled to the electronic device 110 via an RCA jack or other connection. Using the DMA 106, a user may access digital content streamed from the personal computer system 102 on the electronic device 110. In this embodiment, the personal computer system 102 may transmit the content via network 104 to the DMA 106, after which the DMA 106 transmits the content via its connection to the coupled electronic device 110 for viewing, listening, etc. Electronic device 110 may include one or more CE devices such as televisions, displays, stereos, home theaters, CD/DVD players or recorders, multimedia wireless devices, game consoles, broadcast tuners, or any other device with which a user may access digital content.

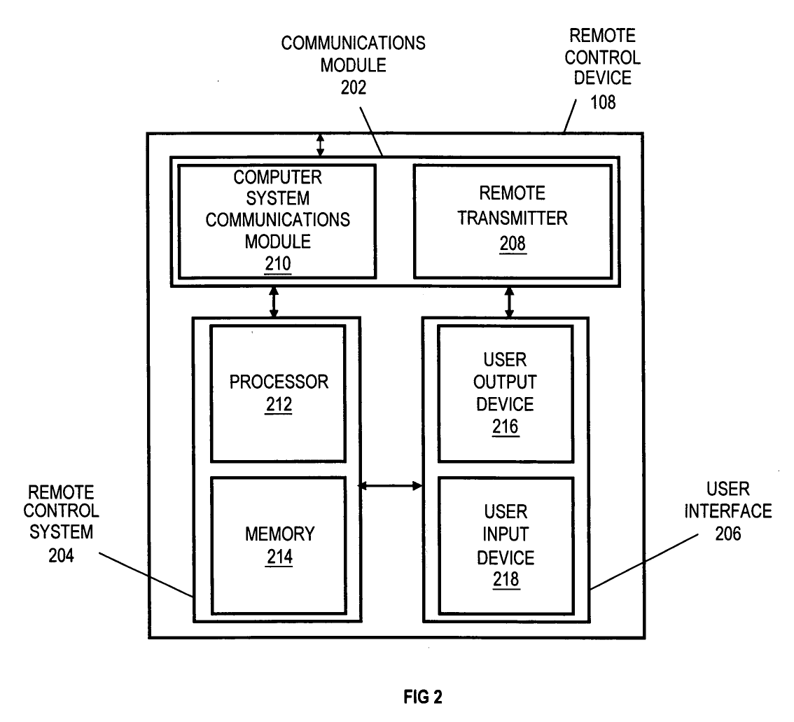

A user may utilize the remote control device 108 to control the DMA 106 and thus the digital content from the personal computer system 102. The remote control device 108 may communicate with the DMA 106 so that the user can send commands to the DMA 106 using the remote control device 108 to control the playback of digital content on the electronic device 110. In an alternative embodiment, the DMA 106 is not used and the remote control device 108 may communicate directly with a network-capable electronic device 110. The remote control device 108 (which is described in more detail in relation to FIG. 2) of the depicted embodiment includes a remote display 114 and a remote keypad 112. The remote control device 108 may use the remote display 114 to display output to a user. The user may use the remote keypad 112 to enter commands or information into the remote control device 108.

As will be described in more detail subsequently, in the disclosed system the user may advantageously view information relating to the occurrence of events at the personal computer system 102 at the remote control device 108, such as on the remote display 114. The user may also interact with personal computer system 102 via the keypad 112 or other input device of the remote control device 108. By interacting with the personal computer system 102 via the remote control device 108, the user may therefore interact with the personal computer system 102 even when the user cannot see the display 126 or use the user input device 128 of the personal computer system 102. In one example, the user may interact with the personal computer system 102 while in another room of the home where they cannot see the display, such as when the user is watching a movie on their home theater system. The personal computer system 102 may notify the user, for example, that a download of new digital content has completed or that user attention is required because of a network issue. In another example, where a user is using the display 126 of the personal computer system 102 to watch full screen digital content, the user may still interact with personal computer system 102 even though the display 126 is fully occupied by utilizing the remote control device 108 and its remote display 114.

FIG. 2 depicts the remote control device 108 of FIG. 1 according to one embodiment. In the depicted embodiment, the remote control device 108 includes a communications module 202, a remote control system 204, and a user interface 206. The communications module 202 may transmit and receive information to and from other components of the user notification system 100. The communications module 202 may include a remote transmitter 208 and a computer system communications module 210 in one embodiment. The remote transmitter 208 may communicate with the electronic device 110 by transmitting information such as commands to the DMA 106 which in turn sends the commands to the electronic device 110. Alternatively (such as when there is no DMA 106) the remote transmitter 208 may directly communicate with the electronic device 110. In one embodiment, the remote transmitter 208 may include an infrared (IR) transmitter for sending IR signals to the DMA 106 and/or electronic device 110. In an alternative embodiment, the remote transmitter 208 may also include a receiver for receiving signals such as IR signals so that status or other information may be received at the remote control device 108. The remote transmitter 208 may use any communication technology to communicate with the DMA 106 and/or electronic device 110, including point-to-point protocols such as Bluetooth® or other radio frequency (RF) based wireless technologies. The computer system communications module 210 may utilize any technology for communication between the remote control device 108 and the personal computer system 102, including utilizing network 104, point-to-point protocols, or communicating through the DMA 106 or electronic device 110. One skilled in the art will recognize that any wireless communications method may be utilized by the remote transmitter 208 or the computer system communications module 210.

The remote control system 204 may include one or more processors 212 and memory 214 to facilitate processing user input, commands for the electronic device 110, user output, or the like. Memory 214 may comprise volatile memory such as random access memory (RAM) or cache or non-volatile memory such as flash memory or battery-backed RAM. The remote control system 204 may also include other components such as batteries or other power supplies.

User interface 206 may include a user output device 216 and a user input device 218. The user output device 216 may include any device adapted to communicate information to a user of the remote control device 108. In one embodiment, the user output device 216 may include a display to provide visual information to the user. The display may be a liquid crystal display (LCD) display or other type of display, such as a display utilizing Microsoft Corporation's Auxiliary Display technology. Alternatively, the user output device 216 may provide auditory information to the user (such as via a speaker or other auditory device) or may provide notification by physical movement, such as vibrating all or part of the remote control device 108 using a vibratory device. One skilled in the art will recognize that the user output device 216 may include any device adapted to provide information or notification to a user. The user input device 218 may include any device adapted to receive user input, such as a keypad, keyboard, mouse, joystick, trackball, touchpad, or speech recognition device.

The components of the remote control device 108 may be located within a physical housing in one embodiment. The remote control device 108 may be a modified remote control for an electronic device 110, or it may be a device with additional functionality such as a personal digital assistant (PDA), mobile phone, wearable device, or other wireless device.

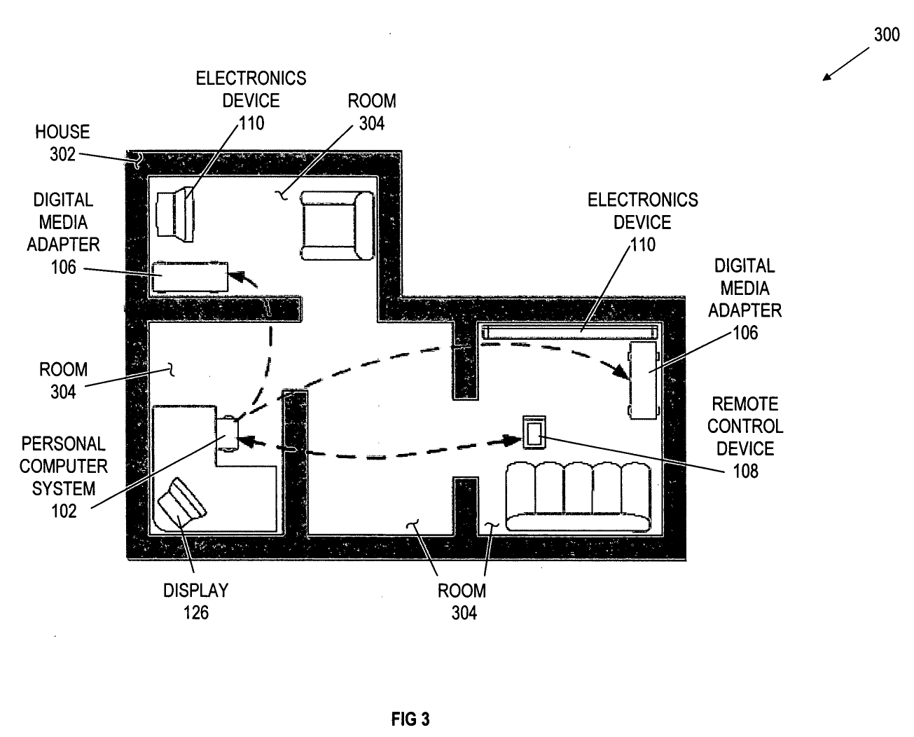

FIG. 3 depicts an embodiment of the system of FIG. 1 implemented in a home network environment. In the depicted embodiment, the user notification system 100 is implemented in a house 302 with multiple rooms 304. The personal computer system 102 may serve as the hub of the home network by managing the wireless distribution of digital content to and between electronic devices 110 located throughout the house 302. As described previously, the personal computer system 102 may interact with the electronic devices 110 via DMAs 106 connected to the electronic devices 110. A display 126 may be connected to the personal computer system 102 for use by a user in viewing messages or content from the personal computer system 102.

In one embodiment, a user may be in one room 304 watching an electronic device 110 that is receiving digital content through a DMA 106 from a personal computer system 102 in a different room. The user may use a remote control device 108 to control the electronic device 110 via the DMA 106. The user, wishing to download a movie from the Internet, may use their remote control device 108 to request the download. The remote control device 108 may transmit the user's request to the DMA 106 which in turn transmits it to the personal computer system 106. While the movie is downloading, they may wish to view a television program in full screen mode on the electronic device 110. When the movie download is complete, the personal computer system 102 may transmit a notification to the user to the remote control device 108 so that the user knows the download has completed. The user may thus receive a notification even though they are in a different room than the personal computer system 102 (and therefore cannot see display 126) and even though the electronic device 110 is in full-screen mode. The methodology of the disclosed embodiments may therefore provide a way of notifying the user of events such as the download completion in a less intrusive way than providing a notice interrupting the full-screen display on the electronics device and without the user having to manually view the display 126 of the personal computer system 102, potentially increasing user satisfaction. The user in this example may optionally respond to the event notification by delaying viewing, switching over the newly downloaded digital content, etc.

The disclosed system may prove particularly useful when a user cannot see display 126 of the personal computer system. For example, a user located in another room 304 from the personal computer system 102 may receive a notification of system or network trouble via the remote control device 108 even though they cannot directly see or hear the personal computer system 102. A user listening to, say, a stereo electronics device 110 may receive a notification on their remote control device 108 (which the user is using to control the stereo) that the personal computer system 102 needs the user's attention for maintenance purposes, providing an effective mechanism for communicating with a user anywhere in the house 302. The personal computer system 102 could also request user input (such as authorization to restart a connection, a password, or authorization to reboot the personal computer system 102) via the remote control device 108, allowing the user to respond to the personal computer system 102 without having to go to the personal computer system 102 and without disturbing their possible access or playback of digital content on an electronics device 110. One skilled in the art will recognize that other embodiments are possible as part of the user notification system 100.

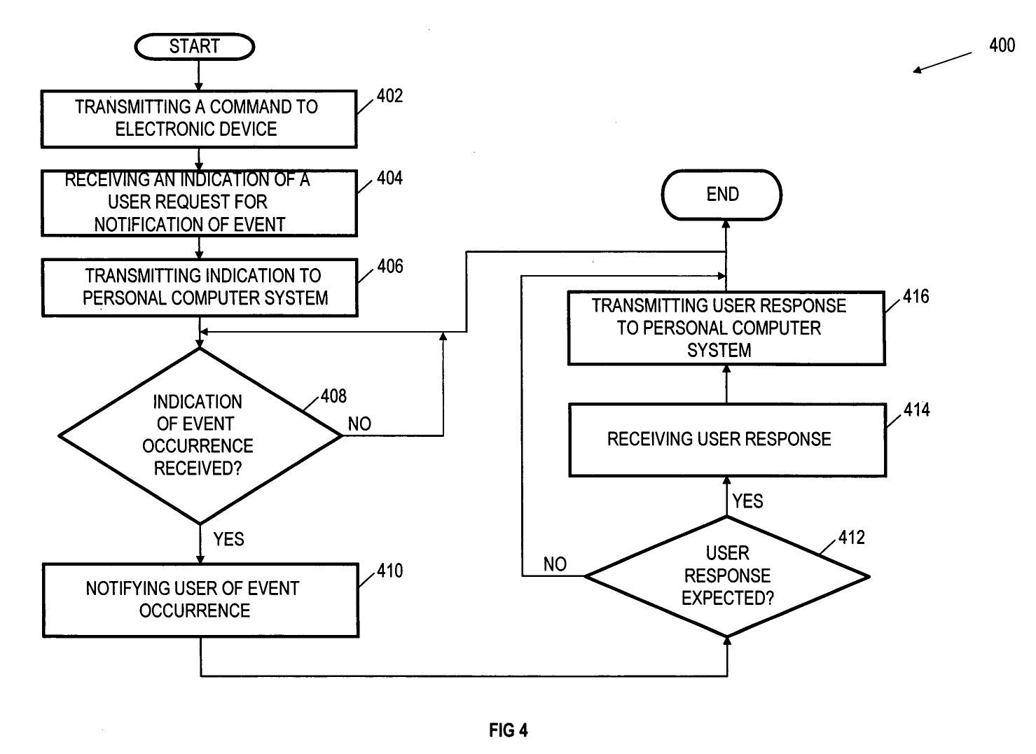

FIG. 4 depicts a flowchart of an embodiment to notify a user of a remote control system of the occurrence of an event. In one embodiment, one or more components of a remote control device 108 may perform the elements of flowchart 400. In the depicted embodiment, flowchart 400 begins with transmitting a command to the electronic device 110 at optional element 402. At element 402, the remote transmitter 208 may transmit a command from the remote control device 108 to the electronic device 110, such as in response to user input. A user, for example, may request that the playback of digital content on the electronic device 110 begin, end, pause, speed up, slow down, or the like using the remote control device 108. Element 402 is optional and may be omitted in some embodiments and, if it is performed, may occur at any time.

Flowchart 400 next continues to element 404, receiving an indication of a user request for notification of an event occurring at a personal computer system 102. In one embodiment, the user input device 218 may receive an indication from the user that they wish to receive communications from the personal computer system 102 at the remote control device 108. In some embodiments, the remote control device 108 may assume as a default that the user desires such information absent user instructions to the contrary. After receiving a request or otherwise determining that notification should happen, flowchart 400 may continue to element 406 where the computer system communications module 210 may transmit the indication to the personal computer system 102.

After transmitting an indication to the personal computer system 102, flowchart 400 continues to decision block 408, where the remote control device 108 determines whether an indication of an event occurrence has been received from the personal computer system 102. In one embodiment, the computer system communications module 210 may receive the indication of an event occurrence from the personal computer system 102 via the computer system communications module 210. Once the indication of an event occurrence has been received, flowchart 400 continues to element 410, where the remote control device 410 notifies the user of the event occurrence. In some embodiment, the user output device 216 may notify the user of the event occurrence by displaying an indication of the event occurrence, by notifying the user with a noise, by vibrating or providing other physical indication of the event occurrence, etc. If no indication of an event occurrence is received, flowchart 400 may return to decision block 408 for continued processing and waiting for such indication. Events at the personal computer system 102 may include any type of information, such as notification of the completion of a task such as a download, the availability of premium or other digital content, the results of system or network diagnostics, advertising, the arrival of e-mails or other communications, time-based alarms, receipt of phone calls, or home security notifications. Other examples may include notification of system or network problems such as storage data integrity problems, network integrity, hard drive problems, etc.

After notifying the user of the event occurrence, flowchart 400 may optionally process a user response to the notification. To do so, flowchart 400 may continue to decision block 412 to determine whether a user response to the notification is expected. If a response is expected, flowchart 400 continues to element 414, receiving a user response via the user input device 218. After receiving the response, flowchart 400 may then transmit the user response to the personal computer system 102 via the computer system communications module 210 at element 416. Once the user response has been transmitted (or in the event no user response was expected or received), flowchart 400 may either terminate or return to decision block 408 for continued processing. User responses may include acknowledgements, answers, requests, commands, or the like made in response to the event notification. For example, a user may respond with an acknowledgement of a message notifying them that, say, network problems were occurring. In another example, a user could request the playback of the new digital content upon receiving notification that download or other preparation of the digital content was complete. Alternatively, the user could request storage or delayed playback of the new digital content and continue performing other tasks or playing back other content. In yet another example, a user could authorize a reboot of the personal computer system 102 in response to receiving a notice of system problems or a network restart.

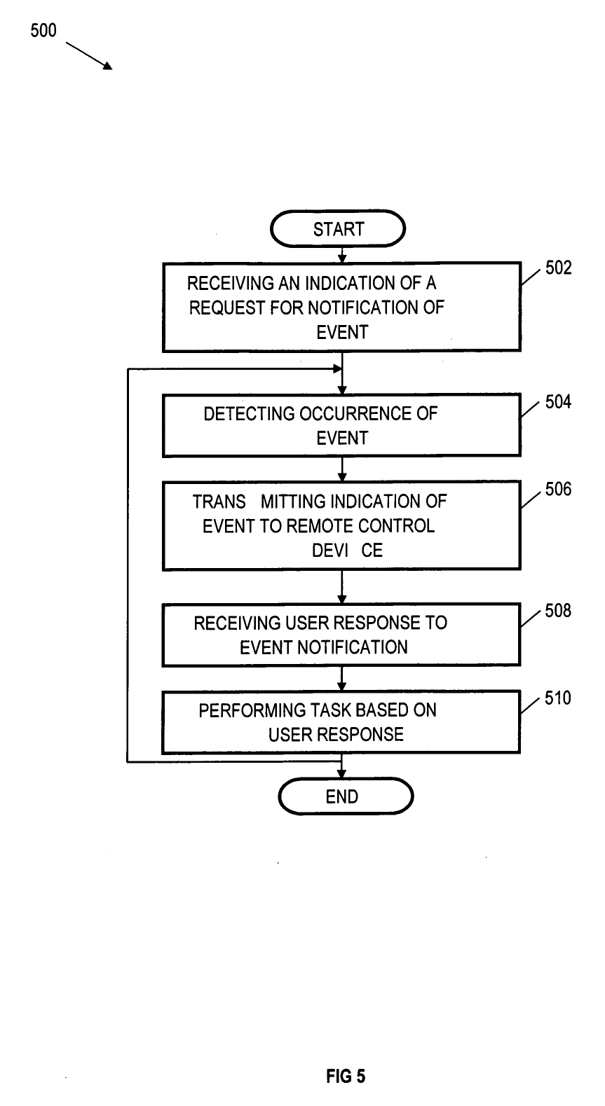

FIG. 5 depicts a flowchart of an embodiment to detect the occurrence of an event and to transmit an indication of the event occurrence to a remote control device. In one embodiment, one or more components of a personal computer system 102 may perform the elements of flowchart 500. In the depicted embodiment, flowchart 500 begins at element 502 with receiving an indication of a request from a user of a remote control device 108 for notifications of particular events of the personal computer system 102. In one embodiment, the remote control module 122 of the personal computer system 102 may receive such request from the remote control device 108. In another embodiment, the user input device 128 of the personal computer system 102 may receive a request directly from the user. In this embodiment, a user may submit a request to receive notifications on a remote control device 108 directly at a personal computer system 102, such as when they are configuring a digital content-based application 124 of the personal computer system 102. In an alternative embodiment, the personal computer system 102 may determine that a user will receive notification of events, such as by basing its determination of a default setting, the type or severity of event, etc.

Flowchart 500 may next continue to element 504, where an application 124 or other component may determine that an event has occurred. As described previously, event occurrence may be based on the completion of a task, the results of an application (e.g., diagnostic results, digital content download completion, etc.), expiration of a time period, or other event. Once an event occurs, flowchart 500 may continue to element 506, where the remote control module 122 transmits a notification of the event occurrence to the remote control device 108, such as via network 104 or point-to-point communications.

After notifying the user of the event occurrence, the remote control module 122 may optionally receive a user response to the event notification at element 508. After receiving the response, an application 124 or other component (such as the digital content manager 120) may perform a task based on the received user response at element 510. For example, if the user response to a notification that download of digital content was complete is a request to playback the content, the digital content manager 120 may stream the digital content to the appropriate electronic device 110. In another example, an application 124 may perform a task such as deleting or storing a file, restarting a program, etc. in response to a user request to do so. After performing the task, flowchart 500 may then either terminate or return to element 504 for further processing.

One embodiment of the invention is implemented as a program product for use with a computer system such as, for example, the user notification system 100 or its components as shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., hard-disk drive or floppy disks within a diskette drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates systems, methods, and media to notify users of events on a remote control device or to otherwise provide interaction between a user of a remote control device and a personal computer system. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A remote control device associated with an electronic device, comprising:
a computer system communications module to receive an indication of an occurrence of an event from a personal computer system;
a processor in communication with the computer system communications module to process the received indication of the event occurrence; and
a user interface in communication with the processor, the user interface comprising a user output device to notify a user of the event occurrence and a user input device to receive commands from a user for the electronic device.

2. The remote control device of claim 1, further comprising a remote transmitter to transmit commands from the remote control device to the electronic device.

3. The remote control device of claim 2, wherein the remote transmitter transmits commands to the electronic device by transmitting commands to a digital media adapter (DMA) coupled to the electronic device.

4. The remote control device of claim 2, wherein the remote transmitter is an infrared (IR) transmitter.

5. The remote control device of claim 1, wherein the computer system communications module comprises logic to transmit to the personal computer system an indication of a response received from a user.

6. The remote control device of claim 1, wherein the computer system communications module receives transmissions via a radio frequency (RF) based wireless network.

7. The remote control device of claim 1, wherein the computer system communications protocol receives transmissions via one or more of a point-to-point communication protocol, an infrared (IR) transmitter, or a network.

8. The remote control device of claim 1, wherein the user output device comprises one or more of a display, an auditory device, or a vibratory device.

9. The remote control device of claim 1, wherein the user input device comprises logic to receive a response to the event occurrence from the user.

10. A method comprising:
receiving, from a personal computer system at a remote control device associated with an electronic device, an indication of an event occurrence at the personal computer system;
processing the indication of the event occurrence by the remote control device to generate a notification of the event occurrence; and
notifying by a user output device of the remote control device a user of the event occurrence.

11. The method of claim 10, further comprising transmitting by the remote control device a command to an electronic device associated with the remote control device.

12. The method of claim 10, further comprising:
receiving by the remote control device a request for notification of an event at the personal computer system; and
transmitting by the remote control device an indication of the notification request to the personal computer system.

13. The method of claim 10, further comprising:
receiving by the remote control device a user response to the notification of the event occurrence; and
transmitting by the remote control device an indication of the user response to the personal computer system.

14. The method of claim 10, wherein the event occurrence comprises one or more of the completion of a task, the availability of digital content, diagnostic results, advertising, the arrival of communications, alarms, notification of a system problem, notification of a network problem, or home security notifications.

15. A machine-accessible medium containing instructions effective, when executing in a data processing system, to cause said data processing system to perform operations comprising:
receiving, from a personal computer system at a remote control device for an electronic device, an indication of an event occurrence at the personal computer system;
processing the indication of the event occurrence by a processor to generate a notification of the event occurrence; and
notifying by a user output device of the remote control device a user of the event occurrence.

16. The machine-accessible medium of claim 15, further comprising transmitting by the remote control device a command to an electronic device associated with the remote control device.

17. The machine-accessible medium of claim 15, further comprising:
receiving by the remote control device a request for notification of an event at the personal computer system; and
transmitting by the remote control device an indication of the notification request to the personal computer system.

18. The machine-accessible medium of claim 15, further comprising:
receiving by the remote control device a user response to the notification of the event occurrence; and
transmitting by the remote control device an indication of the user response to the personal computer system.

19. The machine-accessible medium of claim 15, wherein the event occurrence comprises one or more of the completion of a task, the availability of digital content, diagnostic results, advertising, the arrival of communications, alarms, notification of a system problem, notification of a network problem, or home security notifications.

20. A method comprising:
receiving a request for notification of an occurrence of an event at a personal computer system;
detecting at the personal computer system the occurrence of the event; and
transmitting an indication of a notification of the occurrence of the event by the personal computer system to a remote control device associated with an electronic device.

21. The method of claim 20, further comprising:
receiving by the personal computer system from the remote control device an indication of a user response to the notification; and
performing by the personal computer system a task based on the received user response.

22. The method of claim 20, further comprising before transmitting the indication of the occurrence of the event, determining that a display of the personal computer system is unavailable.

23. The method of claim 20, receiving a request for notification of an occurrence of an event at a personal computer system comprises receiving the request from the remote control device.

24. The method of claim 20, wherein receiving a request for notification of an occurrence of an event at a personal computer system comprises receiving the request via a user input device of the personal computer system.

25. The method of claim 20, wherein the event occurrence comprises one or more of the completion of a task, the availability of digital content, diagnostic results, advertising, the arrival of communications, alarms, notification of a system problem, notification of a network problem, or home security notifications.
